(19) United States
(12) Patent Application Publication
(10) Pub. No.: US 2013/0183410 A1
(43) Pub. Date: Jul. 18, 2013

(54) NUT AND DRIED FRUIT SNACK FOOD PRODUCT

(71) Applicants: Joseph SETTON, Commack, NY (US); Mia COHEN, Terra Bella, CA (US)

(72) Inventors: Joseph SETTON, Commack, NY (US); Mia COHEN, Terra Bella, CA (US)

(21) Appl. No.: 13/713,673

(22) Filed: Dec. 13, 2012

Related U.S. Application Data
(60) Provisional application No. 61/586,322, filed on Jan. 13, 2012.

(51) Int. Cl. A23L 1/36

(52) U.S. Cl. CPC A23L 1/36
USPC 426/93

(57) ABSTRACT

This application relates to a snack food product, and more particularly, to a snack food product food product that contains just two solid ingredients (nuts and dried fruits) and a syrup. In certain embodiment the snack food product contains pistachios, dried cranberries, agave and brown rice syrup.

### RELATED APPLICATIONS

This application claims priority to U.S. provisional application 61/586,322 filed on Jan. 13, 2012, which is herein incorporated by reference.

### BACKGROUND OF THE INVENTION

This application relates to a nut and dried fruit snack food product, and more particularly, to a nut and dried fruit snack food product that contains just two solid ingredients (nuts and dried fruits) and a syrup.

### SUMMARY OF THE INVENTION

Embodiments of the invention provide a nut and dried fruit snack food product consisting essentially of two solid ingredients and a syrup. The two solid ingredients are a nut or mixture of nuts and a dried fruit or mixture of dried fruits. In certain embodiments the nut is pistachio and the dried fruit is dried cranberries and the syrup is a mixture of agave nectar syrup and brown rice syrup.

Certain embodiments of the invention include a pistachio-cranberry snack food product consisting of cooked whole kernel pistachios at 46.6 weight percent; cooked split kernel pistachios present at 15.5 weight percent; dried cranberries present at 20.60 weight percent; a syrup mixture present at 17.3 weight percent; cranberry flavor at 0.5 weight percent; sunflower oil at 0.5 weight percent; and sea salt present at 0.3 weight percent; wherein the syrup mixture consists of agave nectar syrup at 10.7 weight percent and brown rice syrup at 5.3 weight percent.

In certain embodiments, the snack food product is sized at a thickness of about 9 mm to about 15 mm, and a width of about 24 mm to about 45 mm, and a length of about 30 mm to about 65 mm, and is produced so the final product has four cut sides.

In certain embodiments, the snack food product contains no added vitamins or mineral supplements and has only about 5 mg or less of sodium per 20 gram serving.

In certain embodiments the preparation of the nut and dried fruit snack food product does not involve cooking or baking of the snack food product.

### BRIEF DESCRIPTION OF THE DRAWINGS

FIG. 1 shows a perspective view of one of the snack food products of the invention comprising pistachios and dried cranberries.

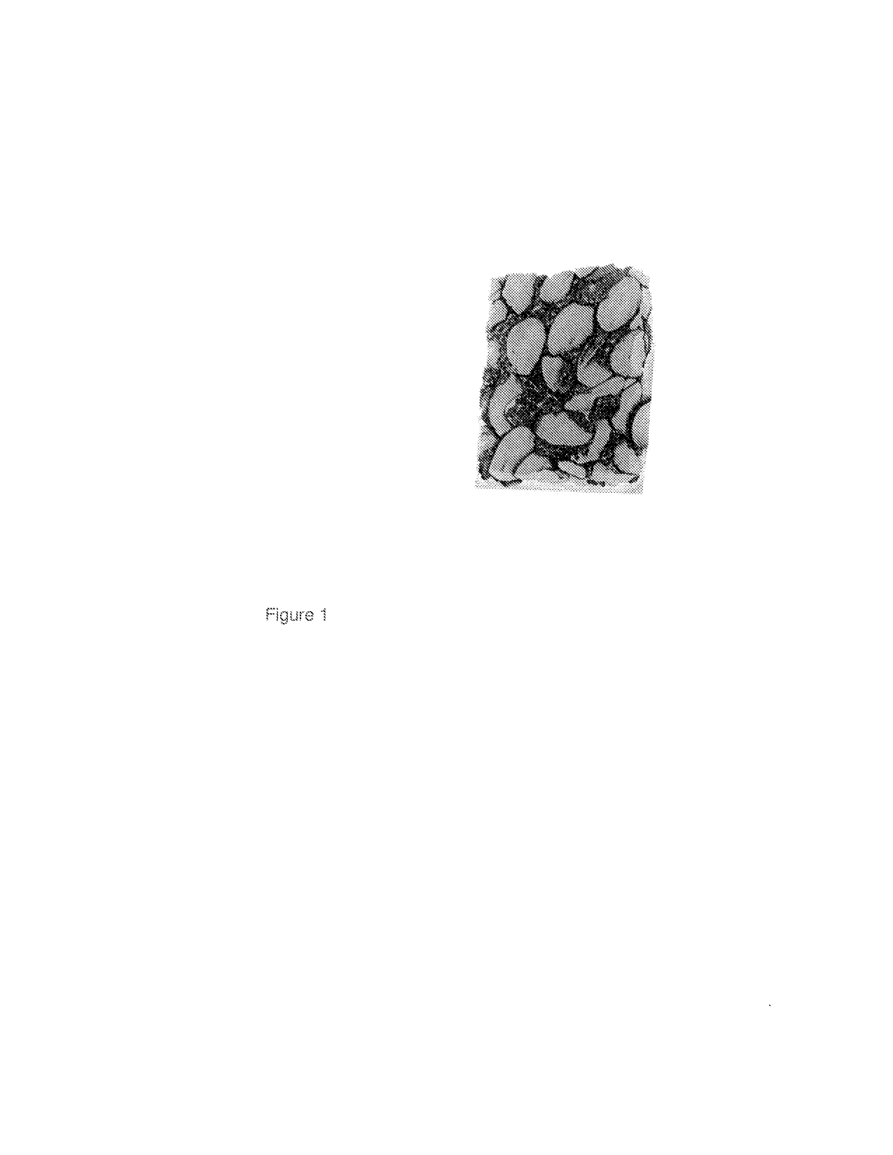

FIG. 2 depicts one of the individual nut and dried fruit snack food product portions showing two of the cut edges of the product and individually wrapped in a clear package.

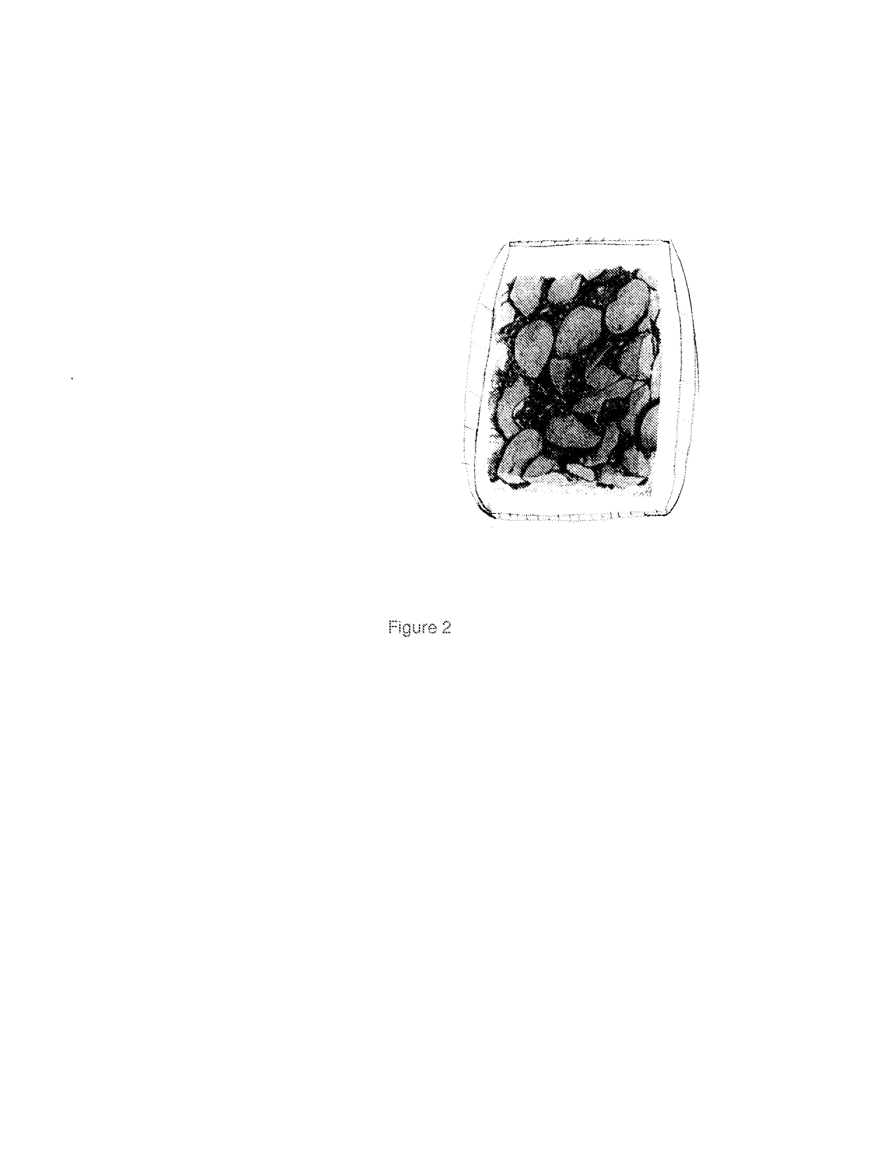

### DETAILED DESCRIPTION

Embodiments of the invention provide a nut and dried fruit snack food product that is made up of two solid ingredients (nuts and dried fruit) and a syrup or mixture of syrups to bind the solid ingredients together. Common snack food bars on the market are not made up of just two solid ingredients as they usually contain other solid materials like flour, oats, bran, rice (flour), wheat germ, etc. to hold the ingredients together. In contrast, embodiments of the invention have only a syrup or mixture of syrup holding the two solid ingredients together. Further, the snack food product is not baked or cooked as most currently available fruit and nut snack food products. Before inserting the product into a bar machine, which is the sheet making & cutting process, all the ingredients are heated up at 150° F. in the tumbler to mix them homogeneously. Unexpectedly and with some difficulty, the inventors of embodiments described herein made a snack food product using just two solid ingredients that also does not require baking. Using just two ingredients, the inventors had to overcome problems in the industry typically solved by using more than two solid ingredients and/or baking. For example, to hold the snack food product together as well as to achieve a consistent/uniform looking product manufactures of other snack bars use more than two solid ingredients and also baked or cooked the product. In the past, manufacturers used these additional ingredients to “fill in the gaps” and bind the products to hold together during the manufacturing and processing process, as well as during the shipping of the product. In contrast, embodiments of the invention are made by combining raw or cooked nuts and dried fruit with a syrup and then this mixture is processed so it is pressed or rolled into a sheet, which is later cut into individual, bite sized snack food product portions.

Any nut can be used in the snack food product, such as, but not limited to, cashews, almonds, hazelnuts, pistachios, macadamias, Brazil nuts, and pecans. The nuts can be whole nuts, nut splits and nut pieces. In certain preferred embodiments the majority of the nuts are whole nuts or nut splits as this provides a pleasing appearance to the snack food product. The nuts can be raw or cooked/roasted. In certain embodiments the nut is pistachio and the snack food product is from about 30%-90% weight percent whole kernel pistachios, and about 0%-20% weight percent split kernel pistachios. In certain embodiments, the total percentage of nuts (whole, splits and pieces) in the food product range from 30-80%, 40-75%, 50-75%, 50-65%, or 50-62% or is 65%, 66%, 64%, 63%, 62%, 61%, 60%, 59%, 58%, 57%, 56%, 55%, 54%, 53%, 52%, 51%, 50%, 49%, 48%, 47%, 46%, or 45% of the total weight. In certain embodiments, the pistachios that are used in the snack food product are known in the industry as “sinkers,” which are pistachios with kernels having a weight that is at least 50% of the total weight of the pistachio. They are typically green in color and occupy almost 100% of the space inside the pistachio shell.

Any dried fruit can be used in the snack food product, such as, but not limited to, raisins, cranberries, cherries, berries, apricots, peaches, nectarines, pears, apples, pineapple, kiwi fruit, mango, papaya, and coconut. In certain embodiments the fruit is diced into pieces. In certain embodiments, the fruit is diced into a size that is similar to the nut pieces. In certain embodiments the dried fruit is cranberry. In certain embodiments the dried cranberries include sunflower oil mixed therein. In certain embodiments, the snack food product contains 5%-45% weight percent dried fruit. In certain embodiments, the snack food product contains 20 to 45% 25-40%, or 25-35%, 45%, 39%, 38%, 37%, 36%, 35%, 34%, 33%, 32%, 30%, 29%, 28%, 27%, 26%, 25%, 24%, 23%, 22%, 21%, or 20% weight dried fruit.

A syrup with or without additives may be added for flavoring as well as a binder and/or thickener. The syrup can be any suitable syrup including, but not limited to Agave nectar syrup, Barley malt syrup, Birch syrup, Brown rice syrup, Chocolate syrup, Corn syrup, Fruit syrup, Golden Syrup, Hickory syrup, Honey, Inverted sugar syrup, Kithul treacle, Maple syrup, Molasses, Palm syrup, Sorghum syrup, Sugar beet syrup, Syrup of Maidenhair, Torani, Treacle and Yacon syrup. In certain preferred embodiments the syrup is a mixture of syrups. In certain embodiments the syrup mixture is agave and brown rice syrup.

In a preferred embodiment, the snack food product includes about 30%-90% weight percent whole kernel pistachios, about 0%-20% weight percent split kernel pistachios, and about 5%-45% weight percent cranberries. In another preferred embodiment, the snack food product has a total nut concentration from about 50% to about 65% total nut concentration and about 5%-45% weight percent cranberries. In another preferred embodiment, the snack food product has a total nut concentration of about 62% total nut concentration and about 5%-45% weight percent cranberries. In another preferred embodiment, the snack food product has a total nut concentration of about 62% total nut concentration and about 37% weight percent cranberries.

In other embodiments, the nut or mixture of nuts is about 20-90% weight nuts and between about 5% to 45% weight percent dried fruit. In certain embodiments, the total percentage of nuts (whole, splits and pieces) in the food product range from 30-80%, 40-75%, 50-75%, 50-65%, or 50-62% or as described herein.

In other embodiments, the nuts consist of a mixture of whole nuts and nut splits at about 30%-90% weight percent, and nut pieces at about 0%-20% weight percent, and dried fruit at about 5%-45% weight percent.

The nut and dried fruit snack food product of the present invention contains no added vitamins or minerals, which is unlike most of the snack food products on the market today.

The snack food product also has a chewy texture as opposed to a crisp hard granola type texture or a cake-like or soft cookie-like texture. This desired texture is achieved by the combination of nuts, syrup and dried fruit and also because the snack food product is not baked or cooked. The snack food product is preferably prepared by separately cleaning and selecting the nuts and cooking them (if not to be used raw in the snack food product) and independently drying the fruit. In certain embodiments the dried fruit is diced or chopped. In certain embodiments the dried fruit is diced or chopped so it is similar in size to the nut pies. These products are then combined together with one or more syrups and the combination is mixed for uniformity and fed through a processing machine to form a sheet of the product at a thickness of about 9 mm to about 15 mm. The sheet is then cut into individual snack food product portions so that each side of the snack food product has a cut edge and is about 24 mm to about 45 mm wide and about 30 mm to about 65 mm long. In certain preferred embodiments, the cut edge is a square or straight cut (as opposed to a rounded, sloped edge). Each side having a cut edge provides a unique appearance that shows the consumer the make-up of the snack food product (just nuts and dried fruit). Further, the cut edge allows the consumer to see that the snack food product is full of nuts and fruit and contains no fillers such as flour, wheat, oats, other grains, etc.

Preferably the snack food product is portioned so that it is a rectangle and is about a 20 gram serving size and thus contains just a little over 100 calories. The size of the snack food product is a “bite sized” portion as opposed to a typical snack food bar that is much larger (around 40 grams). In certain embodiments the bite sized portion is individually wrapped in a clear packaging material, which includes but not limited to cellophane, so that the snack food bar is visible.

In one embodiment, the snack food product of the present invention consists essentially of or consists of whole kernel pistachios present at 46.6 weight percent, split kernel pistachios present at 15.5 weight percent, dried cranberries present at 20.60 weight percent and syrup present at 17.3 weight percent; cranberry flavor 0.5 weight percent, sunflower oil at 0.5 weight percent, and sea salt present at 0.3 weight percent. The syrup preferably consists of agave nectar syrup at 10.7 weight percent and brown rice syrup at 5.3 weight percent.

In a preferred embodiment the snack food product is sized at a thickness of about 9 mm to about 15 mm, and a width of about 24 mm to about 45 mm, and a length of about 30 mm to about 65 mm; has four cut sides; contains no added vitamins or mineral supplements; has a chewy texture, was not cooked or baked, and has only 5mg or less of sodium per 20 gram serving.

1. A nut and dried fruit snack food product consisting essentially of two solid ingredients and a syrup, wherein the two solid ingredients are a nut or mixture of nuts and a dried fruit or mixture of dried fruits.

2. The nut and dried fruit snack food product of claim 1, wherein the snack food product is not baked or cooked.

3. The snack food product of claim 1 wherein the nut is selected from group consisting of cashews, almonds, hazelnuts, pistachios, macadamias, Brazil nuts, and pecans.

4. The snack food product of claim 1 wherein the dried fruit is selected from the group consisting of raisins, cranberries, cherries, berries, apricots, peaches, nectarines, pears, apples, pineapple, kiwi fruit, mango, papaya, and coconut.

5. The snack food product of claim 1 wherein the syrup is selected from the group consisting of Agave nectar syrup, Barley malt syrup, Birch syrup, Brown rice syrup, Chocolate syrup, Corn syrup, Fruit syrup, Golden Syrup, Hickory syrup, Honey, Inverted sugar syrup, Kithul treacle, Maple syrup, Molasses, Palm syrup, Sorghum syrup, Sugar beet syrup, Syrup of Maidenhair, Torani, Treacle and Yacon syrup or mixtures thereof.

6. The snack food product of claim 5 wherein the syrup is a mixture of agave and brown rice syrup.

7. The snack food product of claim 1 wherein the nut or mixture of nuts is present at about 20-90% weight percent and wherein the fruit is present at about 5% to 45% weight percent.

8. The snack food product of claim 7 wherein the nuts consist of a mixture of whole nuts and nut pieces/nut splits and wherein the percent whole nuts are from about 30%-90% weight percent, and wherein the percent nut pieces are between about 0%-20% weight percent.

9. The snack food product of claim 1 wherein the nuts are present at about 50-65% and the wherein the fruit is present at about 5 to 38%.

10. The snack food product of claim 1, wherein the snack food product contains no added vitamins or minerals.

11. The snack food product of claim 1 wherein the snack food product has a chewy texture.

12. The snack food product of claim 1 wherein the snack food product is prepared by mixing the nuts with the dried fruit and the syrup and processed to form a sheet that is processed to a thickness of about 9 mm to about 15 mm, and wherein the sheet is cut into individual snack food products so that each side of the snack food product has a cut edge and is about 24 mm to about 45 mm wide and about 30 mm to about 65 mm long.

13. A nut and dried fruit snack food product consisting of cooked whole kernel pistachios at 46.6 weight percent; cooked split kernel pistachios present at 15.5 weight percent; dried cranberries present at 20.60 weight percent; a syrup mixture present at 17.3 weight percent;
cranberry flavor at 0.5 weight percent; sunflower oil at 0.5 weight percent; and sea salt present at 0.3 weight percent;
wherein the syrup mixture consists of agave nectar syrup at 10.7 weight percent and brown rice syrup at 5.3 weight percent;
wherein the snack food product is sized at a thickness of about 9 mm to about 15 mm, and a width of about 24 mm to about 45 mm, and a length of about 30 mm to about 65 mm;
wherein the snack food product is produced so the final product has four cut square sides;
wherein the snack food product contains no added vitamins or mineral supplements;
wherein the preparation of the snack food product does not involve cooking or baking of the snack food product;
wherein the snack food product has only about 5 mg or less of sodium per 20 gram serving; and
wherein the snack food product has a chewy texture.
